(19) United States
(12) Patent Application Publication
(10) Pub. No.: US 2008/0221931 A1
(43) Pub. Date: Sep. 11, 2008

(54) METHOD AND SYSTEM TO ENABLE FOLLOWING A MEDICAL PROCEDURE FROM A REMOTE LOCATION

(76) Inventors: Sebastian Schmidt, Weisendorf (DE); Sabine Schaeffer-Kundler, Herzogenaurach (DE)

Correspondence Address: SCHIFF HARDIN, LLP;PATENT DEPARTMENT, 6600 SEARS TOWER, CHICAGO, IL, 60606-6473, US

(21) Appl. No.: 12/044,142

(22) Filed: Mar. 7, 2008

(30) Foreign Application Priority Data
Mar. 8, 2007 (DE) 10 2007 011 421.6

(51) Int. Cl. G06Q 50/00

(52) U.S. Cl. 705/3

(57) ABSTRACT

In a method and system following an examination or treatment of a patient by means of an imaging medical examination apparatus from an external data processing device with an associated monitor within a facility system having a number of different imaging medical examination apparatuses, data from a database of a facility system, that contains data regarding all examination devices integrated into the facility system and of the patient or patients to be examined with an examination device, and/or of a patient information system that contains data regarding all patients to be examined and the examination devices employed therefore specific to the patients are displayed on the monitor of the external data processing device. A specific displayed examination device or a specific displayed patient is selected with an input unit of the external data processing device. After the selection a data connection is established between the selected data processing device and the selected examination device or the control device thereof associated with the selected patient, such that at least the acquired image data are presented on the monitor of the external data processing device.

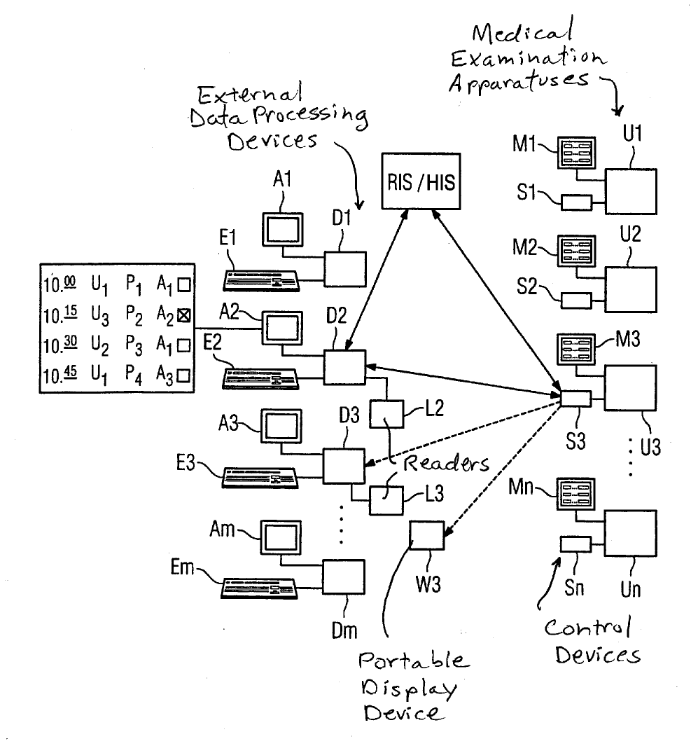

### BACKGROUND OF THE INVENTION

1. Field of the Invention

The present invention concerns a method to enable following an examination or treatment of a patient by means of an imaging medical examination device from an external data processing device with associated monitor within a facility system having a number of different imaging medical examination devices.

2. Description of the Prior Art

In hospitals a number of different imaging medical examination devices are typically present that, in total, form a facility system. An information system is associated with the facility system, for example a “radiological information system (RIS)” when radiological examination devices are concerned. Moreover, a general patient information system (frequently called a “hospital information system (HIS)”) is typically also provided in which patient-specific information such as name, gender, age, illness, treatments implemented or to be implemented, etc. as well as the treating physician or physicians, is stored. These information systems enable the efficient management or various special departments, for example a radiological department if the examination devices are radiological imaging systems. The management of the entire workflow for the examination, thus the planning, the implementation and the finding (diagnosis), are among the typical functionalities. Among other components of a facility information system are worklists that list all examinations for a specific apparatus or for a specific examiner. Which examination presently occurs on which apparatus can be seen anywhere in the radiological department using these data. However, only the system data regarding the examination can be seen; the implementation of the examination cannot be followed. This is disadvantageous when, for example, a physician who is logged into the facility or patient information system determines during the work on his or her data processing device that one of his or her patients is presently being examined and the physician would like to follow (track) this examination. In this case the physician must be present at the apparatus; in larger hospitals this is associated with a significant time loss and under the circumstances they physician may arrive too late after the examination has already concluded.

It is known that a physician can have a control access from an external data processing device to individual (networked) examination apparatuses, for example from DE 100 57 781 B4. The data processing device described therein is the central computer system with which a number of display units are associated. This central computer system communicates with the corresponding control devices of the respective examination apparatuses. The data acquired at the examination apparatus are transferred to the central computer system and cached there, and the data are transferred in real time to the central computer system and there are simultaneously output to the respective associated display device such that the data are presented to the physician working there. When in the image observation they physician comes to the conclusion that a personal intervention is necessary, they physician selects the medical examination apparatus to which the physician would like access by means of an input unit. It is only ensured that they physician can access the control device of the examination device by remote control via the physician's present input device. The selection there ensues using the examination results continuously presented on the display units. The physician does not receive more detailed information there, in particular patient-specific information,

### SUMMARY OF THE INVENTION

An object of the present invention is to provide a method that enables following of an examination or treatment of a patient from an external data processing device in a simple manner based on explicit information provided by the user.

The object is achieved in accordance with the invention by a method of the aforementioned general type with the following inventive steps.

Data from a database of a facility system, which contains data regarding all examination devices integrated into the facility system and of the patient or patients to be examined with an examination device and/or of a patient information system that contains data regarding all patients to be examined and the examination devices employed for these specific patients, are displayed on the monitor of the external data processing device.

A specific displayed examination device or a specific displayed patient is selected with an input unit of the external data processing device.

A data connection between the selected data processing device and the control device of the selected examination device or the control device of the examination device associated with the selected patient is established after the selection, as to cause at least the acquired image data to be presented on the monitor of the external data processing device.

An advantage of inventive method is that it allows an immediate access to an examination device, or the control device thereof, or the image data presented thereat. The physician, who can work at an arbitrary data processing device that is involved in a communication connection with the facility information system and/or the patient information system in the hospital, must merely log into the facility or patient information system so that the information stored there on suitable storage media are displayed to the physician. For example, if the physician logs into the facility information system, the physician receives a display of those examination apparatuses that are integrated into the facility system as well as information as to whether an examination is presently running of those respective apparatuses, or as to when the examination will be terminated, and in particular as to which patient is being examined there. The physician can now select an arbitrary list entry (thus an arbitrary examination device), whereupon a data connection to the examination device or the control device thereof is automatically established. This means that the physician thus immediately has remote access capability to the facility information or patient information system. In order to enable establishment of the data connection, for example, a selection field that the physician can select via the screen cursor or the like is associated with every examination device or every patient when the physician selects, in the patient information system, a specific patient with whom in turn a specific examination device is associated with which that patient is to be examined.

The network addresses of the examination devices or of the associated control devices in the hospital network are known to the relevant information system through a corresponding apparatus database that, for example, can be integrated into the facility information system. The apparatus for the respective examination is thus known from the database itself. Upon selection of the “remote access” field by the physician, the remote access is automatically started and the network address of the target examination apparatus is transferred as a parameter so that the data connection is immediately established or is activated.

For the physician this affords an external access capability that is very simple, fast and above all associated with a large amount of information. Because the physician can directly effect the remote access from an information system, all information present and displayed in the respective information system is available to the physician. The inventive method offers a simple participation possibility for physicians (for example senior physicians or chief physicians) who would like to follow individual examinations (for example with private patients) themselves, or who should participate at least visually in an examination for other reasons. The physician must merely check in the respective information system whether and when an examination relevant or of interest to that physician is occurring, such that the physician can then log in directly on the data processing device (PC) from his or her current work location at the given point in time. It is particularly advantageous that this log-in can proceed from a number of different external data processing devices. It is merely necessary for the external data processing device to be able to communicate with the facility or patient information system, because the logging in or the establishment of the connection to the examination device ensues within this system or from this system. For the treating physicians the inventive method consequently offers a high measure of simplicity and transparency; it also allows the physician to be able to at least visually participate in significantly more examinations than before, and to be able to achieve this from a number of different locations where corresponding data processing devices are present, which differs from log-in being possible from only a central data processing location.

As described, the inventive method in its simplest embodiment offers the possibility of at least being able to visually participate in a running or future examination because at least the image data are transferred to the external data processing devices for output there via the established or activated data connection. According to an embodiment of the invention, in addition to a display of the image data, information to be presented on a monitor of the connected examination device can also be entered with the input unit of the external data processing device. If the physician or observer has no intervention possibility according to the simplest invention realization, a certain intervention possibility is provided to they physician according to this further embodiment. The physician can thus communicate via his or her input unit with the personnel on site at the examination device in that the physician can enter information on his or her input unit that is in turn output (presented) on a suitable monitor of the examination apparatus or the control console thereof. For example, the physician can mark a specific region with a screen pointer (mouse pointer) in the image shown on his or her monitor. Because this image (which is presented in real time) is consequently also shown at the same point in time on the monitor of the examination apparatus, this screen pointer is now likewise reproduced there as well, such that the physician can indicate specific anatomical points or regions. It is also possible for the physician to compose texts via a keyboard that are then reproduced in a specifically allocated field etc. The physician can thus enter into a communication with the persons who conduct the examination and are on site, because the information input at the physician's unit is (regardless of which type) output on the monitor at the examination apparatus, either in the image itself or in a specific information field, and the chief physician can communicate, for example, to the physician active on site as to (inter alia) what should be examined next, for example.

It is also possible to provide a further, deeper level of interaction. In an embodiment, the input of control commands to the examination apparatus to control the apparatus can ensue via the physician's input unit. According to this embodiment, the physician operating at the external data processing device thus has extensive or complete access to the control of the examination apparatus; he or she can thus take over the control from the external location and, for example, set operating parameters of the radiological apparatus or define specific image acquisition planes etc. A remote control of the examination apparatus by the remotely located physician is thus possible, such that he or she can virtually conduct the examination. The takeover of control of the examination apparatus via the external data processing device can be released by a user operating the examination apparatus by providing a release signal to the control device of the examination apparatus. This release by the physician who is active on site is ultimately a safety measure that prevents the remotely located physician from taking over the control and intervening therein while, for example, a running examination has not yet entirely concluded or diverse treatments for a follow-up examination are yet to be effected. The external physician can take over the full control access only when the user (physician, medical technology assistant, etc.) who is on site at the examination apparatus gives the release signal to the control device of the examination apparatus (for example by actuation of a release button, shown, for example, on the monitor, or by some other means).

In order to ensure that only authorized persons can participate in examinations from an external location at all (consequently can thus use the inventive method at all), in a further embodiment of the invention the establishment of the data connection ensues dependent on a prior authentication of the user that is implemented at the external data processing device. The user must thus run through an authentication procedure before he or she can successfully establish a data connection. This can ensue, for example, by the user authenticating at the external data processing device via a chip or a card or biometric features that are all registered by corresponding reader or detection devices that are associated with the external data processing device, or by the input of a password or a PIN. Only when authentication check (that can be executed by the external data processing device or by another data packet system communicating therewith) indicates that this user is actually authorized can the data connection be established commensurate with the type or extent of interventional permission associated with the user.

In an embodiment of the invention, the type of the communication between the examination apparatus and the external data processing device can also be approved dependent on hierarchical access rights of the user authenticated at the external data processing device, such hierarchical access rights being granted to the user on a user-specific basis. As described, different possibilities exist as to the unidirectional or bidirectional communication between the external data processing device and the examination apparatus or the control device thereof. In the simplest case the image data acquired by the examination apparatus can be transferred to the external data processing device; in a further level a bidirectional communication can ensue that allows the external physician to transfer information to the examination apparatus that are output there on a monitor, while in a further level a complete control takeover can ensue on the part of the external user. The respective access or work or communication possibilities can now be hierarchically sub-divided specific to the user. For example, a younger physician may be authorized only to be able to observe the acquired image information while (for example) a senior physician may be authorized to interactively communicate with the personnel on site via the data connection, consequently to exchange bidirectional information, while a complete control access is enabled to the chief physician. A hierarchical rights association with respective persons thus exists, and the data processing device, or another data processing system participating in the framework of the communication, is fashioned to recognize associated hierarchical access rights based on the authentication of the user and to effect or to limit the communication, or the establishment of the data connection, corresponding to the user's actual rights.

In another embodiment of the inventive method, an authentication that is embedded in the framework of access to the respective information system is advantageously used. A user typically must already authenticate himself or herself when that user would like to have access to the facility information or patient information system. Because, as described, the selection of a data connection establishment is inventively directly possible within or from this information system, the already-present authentication can consequently be appropriately accessed so that the user does not have to authenticate himself or herself again.

Because the name of the authenticated user is known to the external data processing device or an intermediate data processing system that, for example, effects the authentication or controls the communication operation, the possibility exists to display the name of the external user on the monitor of the examination apparatus. This is also appropriate so that the person on site is informed that a specific person (who, for example, must be virtually connected so as to function as a controller for the implementation of a specific examination or treatment) is now also actually present.

As described, following an examination from an external location is enabled with the inventive method. This should be enabled primarily with a scope that allows a physician to be able to follow or possibly intervene in the examination of a patient treated by that physician, but not examinations of other patients that are treated by another physician. In an embodiment of the invention, the establishment of a data connection therefore can be limited only to a control device of an examination apparatus at which a patient associated with the authenticated person is being (or will be) examined. As described, the specific items of information with regard to which patient is examined at which examination apparatus and by which physician the patient is being treated are present and are linked with one another in the facility information or patient information system. After an authentication of the person working externally, the system thus can immediately detect whether a selected examination apparatus or a selected patient is associated with this authenticated person or this authenticated physician, and whether this person or this physician is authorized at all to be able to externally participate in the examination of this patient. The access is thus limited only to such persons for whom the authenticated physician is actually responsible.

It may sometimes be necessary to inform specific persons about examinations when such persons, for whatever reasons, should always externally follow a particular examination or type of examination (thus should sometimes participate). For this purpose, in an embodiment of the invention at least some of the persons currently using the database of the facility information system are displayed on the monitor of the examination (in particular after establishment of the data connection), and persons can be selected by the user of the examination apparatus by means of an input unit via the monitor, to whom information is output (i.e., information that is reproducible on their monitors or via another associated display such as, for example, a pager or the like) about the possibility of establishing a separate data connection to the control device of the examination apparatus (at least for a display of the image data on their own monitors). This information is output via the respective data processing device associated with such persons. The user located at the location of the examination apparatus can thus inform specific persons who should participate. According to the invention this also ensues directly from the facility information system in which the operator of the examination apparatus has already logged in. He or she can make a selection on that causes a list of all persons currently logged into the facility information system to be displayed to the operator so that he or she knows all who can be contacted in this way. The operator can now select one or more of these indicated persons to whom information generated individually by the user, or predefined information, is then provided via a communication connection to the external, local computers of those persons, or a pager or the like, with the information then being displayed at those locations. The informed person or persons can then cause a data connection take established via an arbitrary external data processing device after authentication occurs (possibly dependent on hierarchical personal rights). This appropriately ensues in turn directly from the facility information system in which this person may possibly be already logged in anyway. The possibility thus exists to inform various potential participants about a possible remote access session, and those participants can then log in and observe the course of the examination and possibly be able to communicate with the persons on site.

In the previously described embodiment, the examining physician on site can select and inform persons that the examination is available to be externally observed (given interest), it can sometimes be required that a specific person (for example a senior or chief physician) should necessarily at least externally follow the examination. For this purpose, in accordance with the invention a responsible person can be determined automatically by the system by accessing the database of the facility information system when a patient associated with the responsible person is to be examined within a predetermined time span with an examination apparatus integrated into the system. After the automatic determination, information regarding the examination is provided via a communication connection to a data processing device associated with the determined person or to another display associated with that person. If there is an entry in the database of the facility information system indicating that a particular person must be informed under any and all circumstances, suitable information is thus automatically transmitted to this person, either to that person's associated data processing device (thus for example a computer in the office of the physician) or to a portable display or information apparatus (such as, for example, a pager) typically carried by the physician. The physician is thus informed promptly (for example 15 minutes before the beginning of the examination) that a patient in his or her care will be examined shortly, such that he or she can immediately make arrangements in order to participate in the examination, such as by personally going to the examination location or by externally connecting in the inventive manner. The communication can ensue by a hardwired connection or wirelessly (thus by radio).

The inventive method thus allows very simple observation and influencing of examinations by other users of an information system, for example directing physicians or technical specialists. For a chief physician the inventive method enables him or her to direct the examination of his or her patients in a very simple manner, which is sometimes actually required for accounting reasons, but sometimes is not always possible. Moreover, the possibility exists for an expanded quality control.

In addition to the method, the invention also encompasses system for implementation of the method described above. The system includes a number of imaging examination apparatuses, a facility information system that contains data regarding all examination apparatuses integrated into the facility system and data regarding the patient or patients to be examined with those examination apparatuses, and/or a patient information system that contains data regarding all patients to be examined and the patient-specific examination apparatus to be employed. The overall system also includes at least one data processing device with an associated input unit and monitor through which access to the database of the facility information and/or patient information system is possible via a communication connection, with information from the respective selected database being displayed on the monitor. An examination apparatus or a patient can be selected on this monitor, after which a data connection to a selected examination apparatus or to the examination apparatus associated with a selected patient can be automatically established for an at least unidirectional data transfer from the examination apparatus to the data processing device, in order to display the image data of the respective examination apparatus thereat.

The inventive system thus includes a series of diverse hardware and software components, namely diverse imaging medical examination apparatuses (predominantly radiological examination apparatuses), a facility information system including facility computer in which the corresponding data are contained, and/or a patient information system, likewise including a system computer in which the system-specific data are stored, as well as one or more external data processing devices that have access to either the database of the facility information system or the patient information system via suitable communication connections. An appropriate communication ensues between these computers, such that an examination apparatus (in the facility information system) or a patient (in the patient information system) can be selected on the monitor of an external data processing device, after which an at least unidirectional data transfer connection can be automatically established between the external data processing device and the examination apparatus or its control device.

In an embodiment of the invention a bidirectional data transfer can also ensue, for which control signals can be generated by the data processor so that information, which can be displayed on the monitor of the examination apparatus, can be input via the input unit of the external data processing device. For example, according to this invention embodiment the possibility exists to input text information at the external data processing device that is then transferred to the examination apparatus and displayed there. Alternatively, at the external data processing device it is also possible to be able to enter, via the input unit thereof, control commands for controlling the operation of the examination apparatus. These control commands are translated into corresponding control signals and are transferred to the examination apparatus so that a partial or complete control takeover via the external data processor is possible. The externally located physician thus can externally control the examination apparatus remotely.

Furthermore, an authentication unit that registers an authentication input of a user can also be associated with the remote (external) data processing device, so the establishment of the data connection or the type of the data transfer (thus unidirectional or bidirectional, or only information exchange, or exchange of control signals) ensues dependent on the authentication input of the person attempting use. Such a registration unit can be an arbitrary reader for type or magnetic strip card. Authentication via a password or PIN input is also possible (the registration unit would then be registration software). A data connection can be establishable only to a control device of an examination apparatus at which a patient associated with the authenticated person is examined, in order to prevent that following examinations of other patients that are not associated with the respective physician.

### BRIEF DESCRIPTION OF THE DRAWINGS

An embodiment of an inventive system for implementation of the inventive method is shown in the single FIGURE.

### DESCRIPTION OF THE PREFERRED EMBODIMENTS

The system shown in the drawing includes a number of medical procedure apparatuses. In the embodiment shown in the drawing these are imaging medical examination apparatuses U1-Un, for example radiological apparatuses such as x-ray apparatuses or MR scanners etc. Each examination apparatus has a control device S1-Sn as well as a monitor M1-Mn as well as (naturally) further working and operating components that are not shown in detail. The examination apparatuses U1-Un are located at arbitrary locations, for example in a hospital.

Furthermore, the system includes an arbitrary number of data processing devices D1-Dm external to the examination apparatuses U1-Un, which data processing devices D1-Dm are likewise arranged distributed at arbitrary points in the hospital. Each data processing device also has an input unit E1-Em, for example a keyboard, a trackball, a joystick etc. as well as a display device A1-Am (for example a monitor).

Furthermore, the system has a facility information system and/or a patient information system, which are respective databases. If it is assumed that the examination apparatuses U1-Un are radiological imaging medical examination apparatuses, the facility information system shown in the FIGURE is a radiological information system (RIS); the patient information system in the shown example is a hospital information system (HIS) because here the situation is described in a hospital. Each information system is installed in the form of a suitable database that is stored on a likewise joint high-capacity server. The RIS database in particular includes apparatus-specific data as well as planning data (when each patient to be examined on each examination apparatus, etc.) while the HIS database in particular includes patient-specific information such as names, ages, gender, findings, examinations that have been implemented, examinations to be implemented, etc.

A physician or another person can log into the RIS or HIS database via any data processing device D1-Dm. An authentication of the person is initially required for this purpose so that it can be checked whether this person is authorized at all to be allowed to view these data. For this purpose, each data processing device D1-Dm has a suitable authentication arrangement, for example in the form of suitable readers L2 and L3 via which, for example, a chip card or the like can be read in the case of the data processing devices D2 and D3 while the data processing device D1 has authentication software via which a PIN or a password entered through an input unit E1 is authenticated.

If, for example, the physician has logged into the RIS database and authenticated himself or herself via the data processing device D2, relevant RIS data are displayed to him on the display device A2 upon request, for example. An enlarged screen view is shown in the FIGURE as an example. The displayed data contain information regarding pending examinations. The time that specifies the beginning of the examination indicated, then the employed examination apparatus, the examined patient in the next field, then the responsible physician, after which a selection field follows via which the physician can select a specific examination apparatus with which he or she would subsequently like to communicate. In the shown example it is indicated in the first line on the screen that the patient P1 will be examined at 10:00 at the examination apparatus U1. The responsible physician is the physician A₁. In the second line it is indicated that the patient P2 (for whom the physician A₂ is responsible) will be examined at 10:15 at the examination apparatus U3. The patient P3 for whom the physician A₁ is again responsible will be examined at the examination apparatus U2 at 10:30 while a patient P4 for whom the physician A₃ is responsible will be examined at 10:45, again at the examination apparatus U1.

It is assumed that the physician A₂ has authorized himself or herself with regard to the RIS database via the data processing device D2. The physician now sees that the patient P2 in his or her charge will be examined at the examination apparatus U3 at 10:14. The physician would like to participate in the examination via remote data transfer since the physician cannot be present on site, for whatever reasons. For this purpose, the physician selects the right selection box that is marked by an x. With this selection a remote access application (thus a software tool) is started via which a communication connection (thus a data connection to the control device S3 of the examination apparatus U3) is automatically established, as is represented by the communication arrow. The control device S3 can now pose an authorization query to the RIS database as to whether the queried physician A₂ has already been authorized. The already-occurred authentication is thus accessed; the physician does not have to authenticate himself or herself again for the connection establishment.

After establishment of the data connection the possibility now exists for either a unidirectional or a bidirectional data transfer to ensue between the control device S3 (which can be an arbitrary control console or computer, etc.) and the data processing device D2. In the framework of a unidirectional data transfer only the image data that the examination apparatus U3 has acquired and that were correspondingly processed with an image processing means in the control device S3 are transferred to the data processing device D2 at which the images are presented on the display device A2. This ensues in real time, such that the physician A2 sees the same image as the user located on site at the examination apparatus U3. Here the physician A₂ thus only has an observation possibility by viewing the images.

In the framework of a bidirectional data transfer, it is possible in a simple expansion for the physician A₂ to input information at the data processing device D2 via his or her input device E2 (which, as noted, can be a keyboard or a mouse or the like, for example). This information is then provided via the established data connection to the control device S3 and is output on the associated monitor M3. This information can be, for example, input text information or markings or the like drawn with a screen cursor around an image shown on the display device A2, for example, which markings are then correspondingly output on the monitor M3 in the image there. Via the respective monitors the physician can thus enter into an information exchange with the personnel operating on site at the examination apparatus U3 and can given instructions. Naturally it would also be possible to also enable a speech communication over the established data connection with suitable microphones and speakers at the examination apparatus and the data processing device. Persons at a number of data processing devices can possibly also mutually communicate with the physician on site during an examination, such that a real-time dialog is possible.

In a third expansion the possibility exists for the physician A₂ to take over partial or entire control operation of the examination apparatus U3 in the course of the bidirectional communication. The physician can thus access the control device S3 from his or her data processing device D2 via the input unit E2 thereof and control the entire operation of the examination apparatus U3, for example to change image acquisition parameters, define other slice planes, vary generator voltages, etc. The physician thus has the possibility to effect a remote control.

The manner of the respective access (unidirectional or bidirectional in the respective expansion) can also be hierarchically structured, meaning that different access rights can be associated with respective authorized physicians. For example, if the physician A₂ is a younger physician who does not yet possess sufficient experience, only an observation right (for example) can be given to him or her, meaning that he or she is authorized only to be able to observe the acquired real-time images in the framework of a unidirectional data transfer in order to visually participate. A somewhat more experienced physician can give, for example, instructions in the framework of a bidirectional data transfer (thus may enter into an information exchange), while the chief physician or an experienced senior physician naturally can effect the external control, for example; this group would thus have the highest rights.

As represented by the data connection between the control device S3 and the RIS or HIS database, the possibility exists that the RIS or HIS information can also be queried there and displayed on the monitor M3. For a person working there the possibility now exists to have displayed all users logged into the control device S3 (for example from the RIS database), for example the physicians A₁, A₂, A₃ . . . Aₓ. The user at the examination apparatus U3 can now select and determine whether further physicians should be informed and be invited to participate in the remote access session in addition to the already participating physician A₂ (whose name is immediately displayed on the monitor M3 as soon as he or she has logged in). For this a corresponding input mask is displayed on the screen M3, in which input mask, for example, a corresponding selection field is displayed with regard to every indicated physician A₁-Aₓ who is logged in at a given time. As soon as the physician selects this selection field, a corresponding item of information is given to a respective data processing device or another display device via an existing data connection. In the shown example it is assumed that the operator of the examination apparatus U3 is of the opinion that the physician A₃ should be informed, which is why the operator has selected this physician A₃ in the screen mask (not shown in detail) on the monitor M3. Information is then automatically sent to the data processing device D3 (which is arranged in the office of the physician A₃, for example) via the control device S3 over a suitable data connection that is already present or is to be established within the network, which information is visualized there at the data processing device D3. If the physician has a portable display device (as depicted here in the portable display device W3), information is also given to this display device via a radio data link. The physician then receives corresponding information via this display device W3 (for example a pager) independent of whether the physician is currently in the office or not. This information informs the physician that he or she should participate in a subsequent examination at least via remote data transfer. For example, information about the beginning of the examination is also transferred with this information, for example also the patient name, the examination apparatus and the location, etc.

Although the described selection occurs on the part of the user (thus via a person) it is also possible to have an automatic selection made. In this case the control device S3 automatically analyzes the previous data (likewise automatically queried) from the RIS database. It can be analyzed whether a specific entry is present with regard to a specific examination, which entry mandatorily dictates that a specific physician must be informed. This informing, which ensues in the same manner as described above, then automatically occurs via the control device S3 without interaction of a user located on site being necessary.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for enabling following of a medical procedure, selected from the group consisting of medical examinations and medical treatments, of a patient by a medical procedure apparatus from an external data processing device at a location remote from said medical procedure apparatus, said external data processing device having a monitor and an input unit associated therewith, and said medical procedure apparatus being among a plurality of different medical procedure apparatuses at a medical facility, said method comprising the steps of:
accessing data from said external data processing device selected from the group consisting of data from a data base of a facility system of said facility comprising data for all of said medical procedure apparatuses at said facility and respective patients who will interact with the respective medical procedure apparatuses at the facility, and data of a patient information system containing data for all patients who will interact with the medical procedure apparatuses at the facility and a designation of respective specific ones of the medical procedure apparatuses with which each patient will interact;
displaying said data accessed by the external processing device at the monitor of the external processing device;
via the input unit of the external data processing device, selecting a selected item from among the data displayed at the monitor of the external data processing device, said selected item being an item from the group consisting of a specific medical procedure apparatus and a specific patient having an associated medical procedure apparatus associated therewith which the specific patient will interact; and
after selecting said selected item, establishing a data communication connection between the external data processing device and the specific medical procedure device or the associated medical procedure device and, via said data communication connection, presenting said image data at the monitor of the external data processing device during said medical procedure.

2. A method as claimed in claim 1 wherein each of said medical procedure apparatuses has a display monitor associated therewith, and wherein said method comprises entering input information via said input unit of said external data processing device and, via said data communication connection, causing said input information to be displayed at the monitor of the specific medical procedure apparatus or the associated medical procedure apparatus of the selected item.

3. A method as claimed in claim 1 comprising, via the input unit of the external data processing device, entering control commands and, via said data communication connection, operating the specific medical procedure apparatus or the associated medical procedure apparatus of the selected item according to said control commands.

4. A method as claimed in claim 3 comprising requiring affirmative release of said specific medical procedure apparatus or said associated medical procedure apparatus, by an operator thereof on site with said specific medical procedure apparatus or said associated medical procedure apparatus, before allowing said specific medical procedure apparatus or said associated medical procedure apparatus to be controlled by the control command entered via the input unit of the external data processing device.

5. A method as claimed in claim 1 comprising requiring authentification of a user of said external data processing device and establishing said data communication connection only upon said user being authenticated.

6. A method as claimed in claim 5 comprising establishing hierarchical access rights to said selected item, and configuring said data communication connection to limit access to said selected item from said external data processing device according to a level of rights within said hierarchical access rights associated with a user of the external data processing device dependent on said authorization.

7. A method as claimed in claim 5 comprising also allowing access to a network of said facility via said external data processing device and, for access to said network, requiring network authentication of the user of the external data processing device, and automatically using said network authentication as said authentication for establishing said data communication connection between the external data processing device and the specific medical procedure apparatus or the associated medical procedure apparatus of the selected item.

8. A method as claimed in claim 5 wherein each of said medical procedure apparatuses has a display monitor associated therewith, and comprising automatically displaying a name of the authenticated user at the monitor of the specific medical procedure apparatus or the associated medical procedure apparatus of the selected item.

9. A method as claimed in claim 5 comprising, dependent on said authentication, allowing establishment of said data communication connection only to a specific medical procedure apparatus or an associated medical procedure apparatus of the selected item for which a patient associated with the authenticated user is to interact.

10. A method as claimed in claim 1 wherein each of said medical procedure apparatuses has a display monitor associated therewith, and comprising displaying, at said display monitor of one of said medical procedure apparatuses at which a medical procedure is to be implemented, a listing of at least some personnel associated with said facility and allowing an operator, at said one of said medical procedure apparatuses, to select from among the displayed personnel a selected person, and thereafter automatically establishing a communication with a communication device associated with the selected person that informs the selected person that a procedure will be implemented at said one of said medical procedure apparatuses.

11. A method as claimed in claim 1 comprising, in a computer associated with the facility, automatically identifying a person who must be notified upon implementation of a medical procedure at one of said medical procedure apparatuses, and automatically establishing a communication with a communication device associated with said person to notify said person at a predetermined time in advance of the implementation of said medical procedure.

12. A system for enabling following of a medical procedure, comprising:
a plurality of different medical procedure apparatuses at a medical facility that each implement a medical procedure selected from the group consisting of medical examinations and medical treatments, of a patient;
an external processing device at a location remote from each medical procedure apparatus, said external processing device having a monitor and input unit associated therewith;
a data base selected from the group consisting of a data base of a facility system of said facility comprising data for all of said medical procedure apparatuses at said facility and respective patients who will interact with the respective medical procedure apparatuses at the facility, and a data base of a patient information system containing data for all patients who will interact with the medical procedure apparatuses at the facility and a designation of respective specific ones of the medical procedure apparatuses with which each patient will interact;
said external data processing device accessing said data base to obtain data therefrom and displaying said data accessed by the external processing device at the monitor of the external processing device;
said input unit of the external data processing device, allowing selection of a selected item from among the data displayed at the monitor of the external data processing device, said selected item being an item from the group consisting of a specific medical procedure apparatus and a specific patient having a medical procedure apparatus associated therewith which the specific patient will interact; and
after selecting said selected item, said external data processing device establishing a data communication connection between the external data processing device and the specific medical procedure device or the associated medical procedure device and, via said data communication connection, presenting said image data at the monitor of the external data processing device during said medical procedure.

13. A system as claimed in claim 12 wherein each of said medical procedure apparatuses has a display monitor associated therewith, and wherein said data communication connection is a bi-directional connection, and wherein said input unit allows entry of input information and, via said data communication connection, said input information are displayed at the monitor of the specific medical procedure apparatus or the associated medical procedure apparatus of the selected item.

14. A system as claimed in claim 12 wherein said data communication connection is a bi-directional connection and wherein the input unit of the external data processing device allows entry of control commands and, via said data communication connection, operating the specific medical procedure apparatus or the associated medical procedure apparatus of the selected item is operated according to said control commands.

15. A system as claimed in claim 12 comprising an authentication unit that requires authentification of a user of said external data processing device and establishes said data communication connection only upon said user being authenticated.

16. A system as claimed in claim 15 wherein said authentication unit, dependent on said authentication, allows establishment of said data communication connection only to a specific medical procedure apparatus or an associated medical procedure apparatus of the selected item for which a patient associated with the authenticated user is to interact.
